(19) United States
(12) Patent Application Publication
(10) Pub. No.: US 2015/0106166 A1
(43) Pub. Date: Apr. 16, 2015

(54) Interactive Selection and Setting Display of Components in Quality of Service (QoS) Scores and QoS Ratings and Method of Operation

(71) Applicants: Alberto Gutierrez, JR., San Mateo, CA (US); Clarence Fredrick Ames, Belmont, CA (US); Jamil Husain, Bartlett, IL (US)

(72) Inventors: Alberto Gutierrez, JR., San Mateo, CA (US); Clarence Fredrick Ames, Belmont, CA (US); Jamil Husain, Bartlett, IL (US)

(73) Assignee: CARRIER IQ, INC, Sunnyvale, CA (US)

(21) Appl. No.: 14/552,380

(22) Filed: Nov. 24, 2014

Related U.S. Application Data
(63) Continuation-in-part of application No. 13/536,952, filed on Aug. 19, 2012.

(51) Int. Cl. G06Q 10/06

(52) U.S. Cl. CPC G06Q 10/06393
USPC 705/7.39

(57) ABSTRACT

An interactive display apparatus and method for operating a server to trace the origin of data which results in a display of unsatisfactory Quality of Service for a plurality of wireless communication devices and to set thresholds and relative importance of measurements. An apparatus and method to view and set thresholds for discounting scores according to satisfaction.

### CROSS-REFERENCES TO RELATED APPLICATIONS

This application is a continuation in part of application Ser. No. 13/536,952 filed Aug. 19, 2012, which is incorporated by reference in its entirety and benefits from the priority date of applicable subject matter. Terminal disclaimers will be filed upon allowance of any two or more applications.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

1. Technical Field

The field of the invention is within quality of service management systems of radio telecommunications and class 455.

2. Description of the Related Art

Within the realm of communications systems, the accurate and reproducible measurement of Quality of Service is an important success factor. Quality of Service standards have been established for the Internet by the Internet Engineering Task Force, for CDMA based wireless networks by 3GPP2 for CDMA/ANSI-41 based networks, and for GSM and UTMS based technologies by the 3rd Generation Partnership Project (3GPP).

For example, the original scope of 3GPP was to produce Technical Specifications and Technical Reports for a 3G Mobile System based on evolved GSM core networks and the radio access technologies that they support (i.e., Universal Terrestrial Radio Access both Frequency Division and Time Division Duplex modes: FDD and TDD).

The scope was subsequently amended to include the maintenance and development of the GSM Technical Specifications and Technical Reports including evolved radio access technologies (e.g. General Packet Radio Service GPRS and Enhanced Data rates for GSM Evolution EDGE, HSPA, and LTE).

Yet standards committees by definition only endorse the least common denominator agreed to by all participants. And definitions are utilized to deliver agreed services using mechanisms and parameters. They do not necessary represent perceptions of the end user on service quality or performance. Furthermore, each service provider aspires to provide a total quality of service valued more highly by its customers over what a competitor offers. Thus each provider may have and keep confidential its proprietary measures, scores, and rating of what is superior, acceptable, and poor.

Definitions: KPI_DIMENSIONS and Key Performance Indicators

Within this patent application we define and use the term KPI_DIMENSION: KPI_DIMENSION is an independent variable over which any Key Performance Indicator (KPI) is calculated. KPI_DIMENSIONS defines the special dimensions and limits over which the KPI's will be calculated. A “measure” or “metric” can be considered a primitive parameter, for example such as “signal strength,” and “battery life.” A Key Performance Indicator (KPI) represents how these primitive measures are combined to ultimately indicate performance. Each KPI is a combination of primitive parameters which indicate performance. For example, “average” signal-strength could be a KPI comprising a mean or median of many individual instances of the primitive parameter signal-strength. This KPI (i.e., average) then would require the signal-strength to be sampled according to one or more selected “KPI_DIMENSION.”

One or more KPI_DIMENSION defines an N-dimensional space over which the KPIs are calculated. For example, each mobile directory number (MDN) in a set may be have reported its signal strength regularly into a data store. For a KPI-DIMENSION which is a range of time e.g. between 1 pm and 4 pm, there are 100,000 MDNs in the set so that there are 100,000 KPIs representing average-signal strength, one for each MDN, over the busiest hours, corresponding to this KPI_DIMENSION.

Thus it can be appreciated that what is needed is a method for each service provider to define for itself and measure how quality of service is delivered to their individual customers, efficiently assess the total quality of service experienced by millions of customers, identify reasons for poor performance by drilling into KPIs the specific measures which contribute to bad KPIs, identify the customers experiencing the problems, identify areas in their networks which need improvement, and efficiently process large amounts of data to identify which records need additional study and analysis.

### BRIEF SUMMARY OF THE INVENTION

The method comprises controlling a computer display device to present a plurality of Quality of Service Rating which are derived from underlying measures and analysis steps. The display further enables selection and navigation to the component KPIs and metrics which support the Quality of Service Rating. The Quality of Service Rating may be a visual, audio, sensory, graphical, textual, or numerical clue derived from comparing at least one threshold to a Quality of Service score. A total combined Quality of Service score is determined by adjusting from a gross score. The adjustments relate to corrections. The gross score is determined from among the Key Performance Indicators and discounted by user selected satisfaction discount factors. The computer display device is also operable to make selections among KPI, and to set thresholds for satisfaction discounts and for transforming scores to ratings.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic of a network system;

FIGS. 2-6 are flowcharts of methods embodiments;

FIG. 7 is a block diagram of a server apparatus embodiment;

FIG. 8 A-D illustrate inflection points in a satisfaction discount factor function; and

FIG. 9A-F illustrate the displays provided for interactive navigation or selection; and

FIG. 10 is a block diagram of a processor means for embodiment of circuits.

### DETAILED DISCLOSURE OF EMBODIMENTS OF THE INVENTION

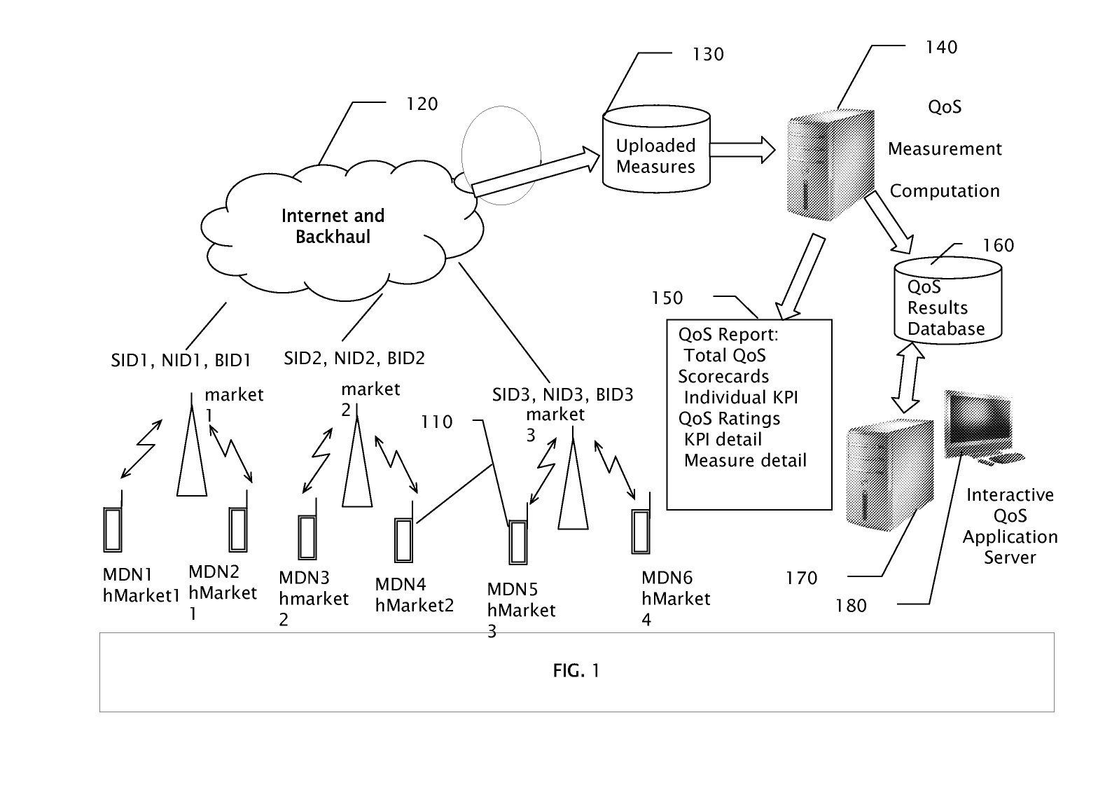

Referring now to FIG. 1, a schematic of a system in a network comprises a plurality of devices configured to collect metrics 110, communicatively coupled through an Internet and backhaul communications network 120, to a uploaded measures store 130, coupled to Quality of Service Measurement Computation Server 140, which writes to a Quality of Service Report Printer 150 and further writes to a computer readable disk file apparatus storing a Quality of Service Results Database 160, said database communicatively coupled to an Interactive Quality of Service Application Server 170 and to a Rating Display and Navigation System 180.

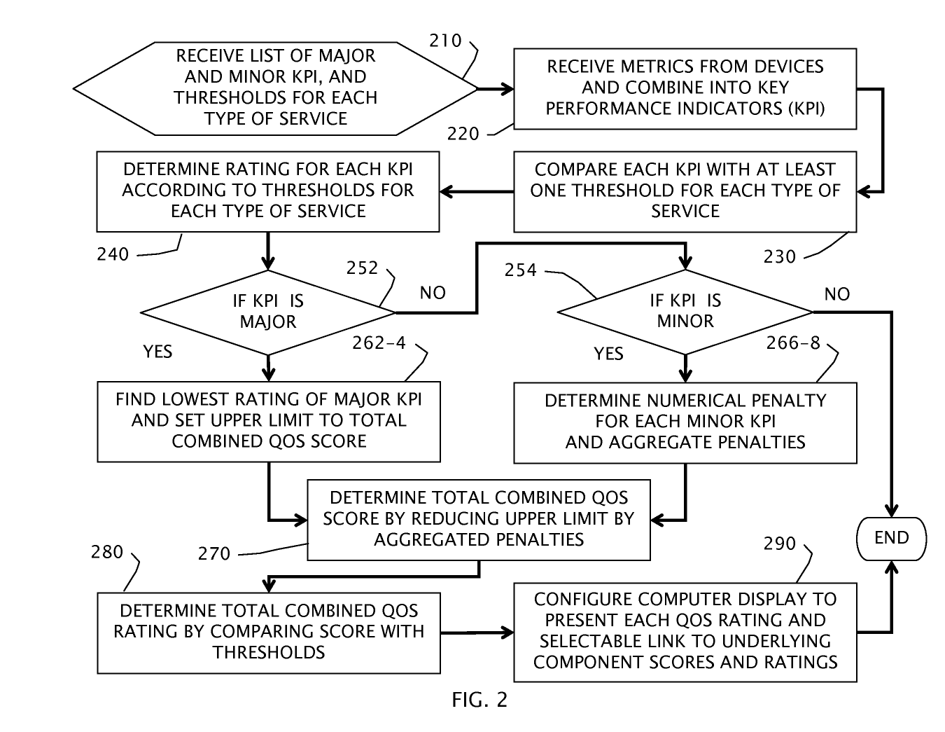

FIG. 2 is a flowchart of an embodiment of a method for controlling a display to present Quality of Service ratings derived from metrics received from devices. The method comprises at a server, receiving a list of Key Performance Indicators and a plurality of thresholds for each KPI for each type of service, and limits or ranges of one or more selected “KPI_DIMENSION” 210.

The method further comprises the step of receiving metrics from a plurality of devices and combining the metrics into Key Performance Indicators KPI 220.

The method further comprises comparing each KPI with at least one threshold for each type of service 230. Note that two distinct types of service may use the same KPI but have different thresholds for what is unsatisfactory. The method further comprises determining a rating for each KPI according to thresholds for each type of service 240. In an embodiment two thresholds divide up the range of KPI into three ratings. N thresholds can divide up the range into N+1 ratings.

In a first embodiment, the method further comprises the step of finding the lowest rating of major KPI 262 and setting the upper limit to a total combined Quality of Service Score to the lowest rating 264, when the KPI is identified as a major KPI 252.

The method further comprises determining a total combined Quality of Service Rating by comparing a score with thresholds 280.

In an embodiment, the metrics received from the devices is transformed into control instructions to configure a computer display to present each Quality of Service rating and a selectable link to underlying component scores and ratings 290. That is, the computer display provides means for selecting an unsatisfactory rating to discover the total combined QoS score, and further displaying the ratings of all the KPI making up the total score, and further selectively displaying the metrics which were combined into the one or more KPI's which cause the Total Combined QoS Rating to be below a threshold.

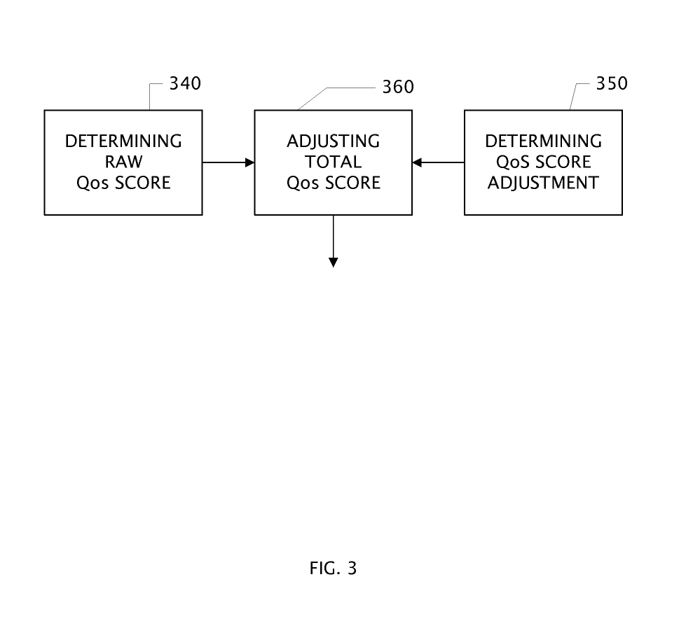

FIG. 3 is a flowchart of a method comprising determining a raw Quality of Service Score 340; and discounting the Total Quality of Service Score by a percentage 360.

In an embodiment, determining the raw Quality of Service Score comprises receiving a plurality of Key Performance Indicators assigned to bins, counting the number of Key Performance Indicators assigned to each bin, computing a score based on the bin having a largest number of Key Performance Indicators.

In an embodiment, the lowest Key Performance Indicator determines a ceiling for the Total Adjusted Score.

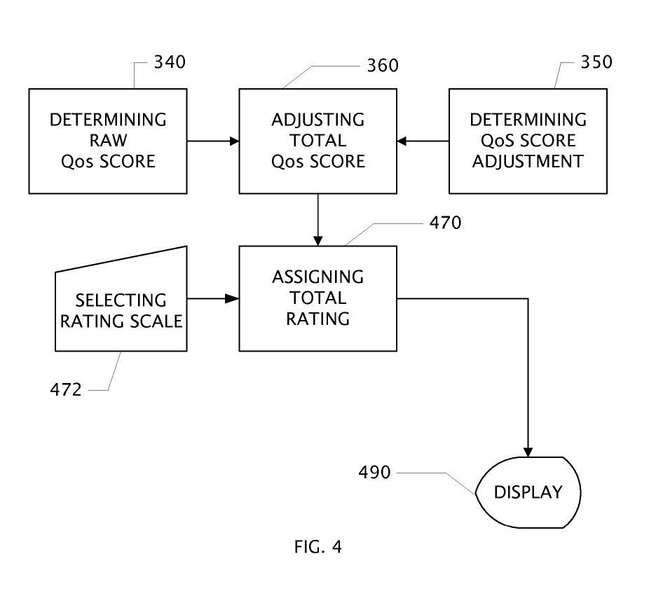

Referring now to FIG. 4, Quality of Service is more easily analyzed over large population if displayed visually as graphs, charts, colors, or descriptive ratings.

In an embodiment, displaying comprises a stacked bar chart showing the relative percentage of each service in each rating.

In an embodiment, displaying comprises a plurality of pie charts showing the relative sizes of each served population and the portion enjoying each rating of QoS.

In an embodiment, displaying comprises showing a plurality of colored icons representing service recipients which icon if selected displays underlying scores and ratings, which determined the adjusted total score.

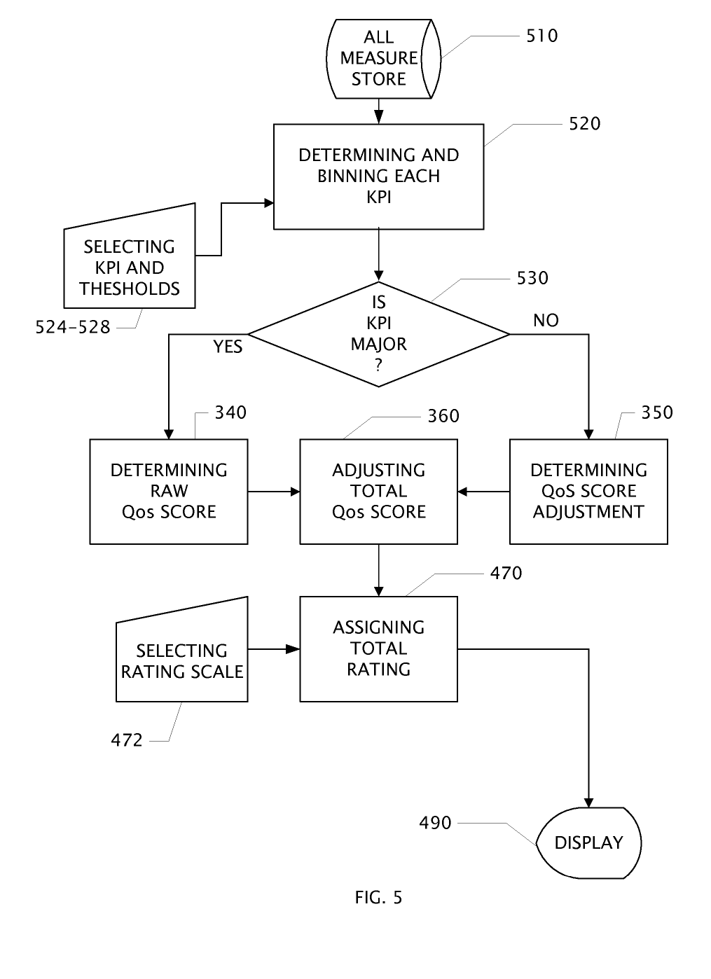

Referring now to FIG. 5, the method further comprises retrieving measures from an all measure store 510, receiving the selected Key Performance Indicators (KPI) to compute 524 and at least one threshold for each KPI 526, determining each selected KPI and assigned each KPI to a bin according to the threshold(s) wherein N thresholds determine N+1 bins 520.

It is understood that the methods of computing each KPI are intended to be stable even though new KPI may be defined for new purposes. However a specific KPI may be major for one service and not major for another, and yet even not useful at all for measuring quality of service for some service type. Similarly the bins for KPI may not be the same in all services so the thresholds used to bin each KPI may be selectable for various services.

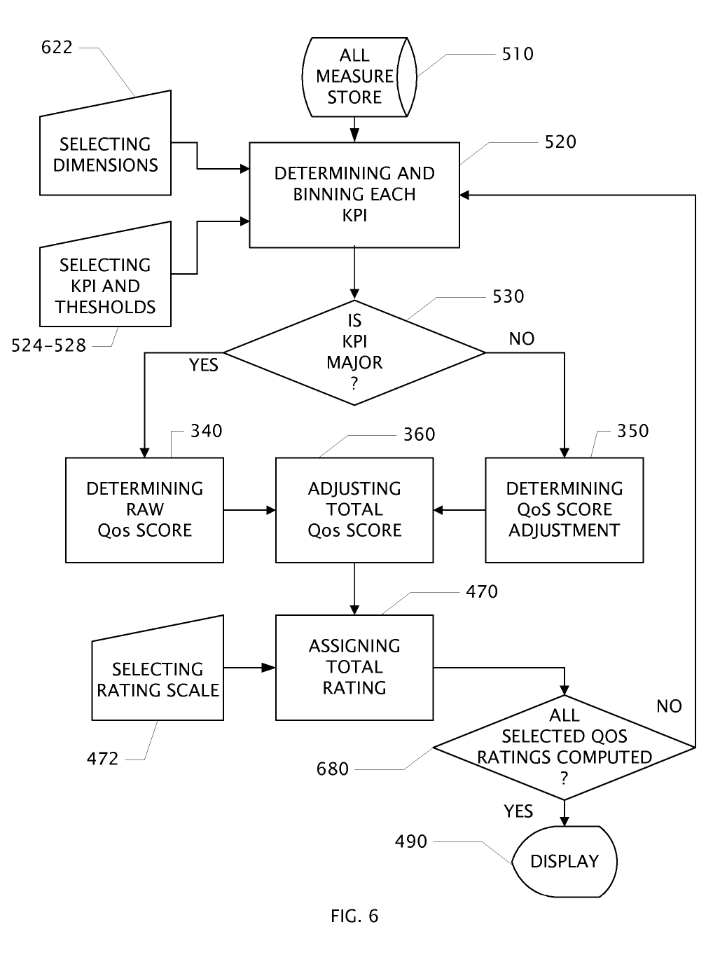

Referring now to FIG. 6, to better understand the causes of variations in quality of service, it is desirable to select dimensions on which to vary the measures of the services to be scored. The method further comprises selecting dimensions 622 to control which of the all measure store is accessed as part of determining and binning each KPI, and continuing the process until all selected QoS ratings have been computed 680.

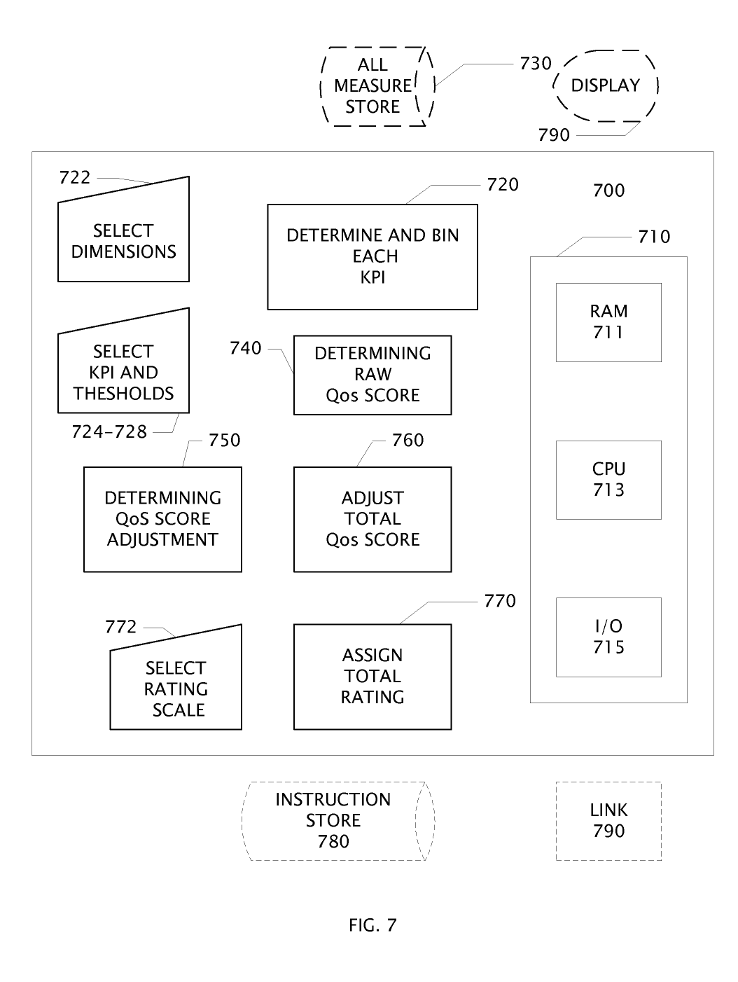

Referring now to FIG. 7 a system embodiment of the invention comprises an apparatus 700 communicatively coupled to an all measure store 730 and to a display 790. The apparatus is further coupled to a link interface 790 and to an instruction store 780. The apparatus comprises a processor 710 which is configured by the instruction store to perform transformative operations of the claimed methods. The processor 710 comprises random access memory 711, a central processing unit 713 configured by the instructions of the instruction store, and an input output control unit 715 for receiving and transmitting data and instructions. The apparatus further comprises a circuit to determine and bin each key performance indicator 720, a circuit to determine a raw score 740, a circuit to determine a Quality of Service score adjustment 750, and a circuit to adjust the total quality of service score 760. In an embodiment, the circuit to determine and bin each KPI is coupled to a circuit to select dimensions 722. In an embodiment, the circuit to determine and bin each KPI is coupled to a circuit to select KPI and thresholds 724 and 728. In an embodiment, the circuit to adjust the total score is coupled to a circuit to assign a total score rating 770. In an embodiment, the circuit to assign a total score rating is coupled to a circuit to select a rating scale. It is known in the art that circuits may be emulated by a processor configured by instructions.

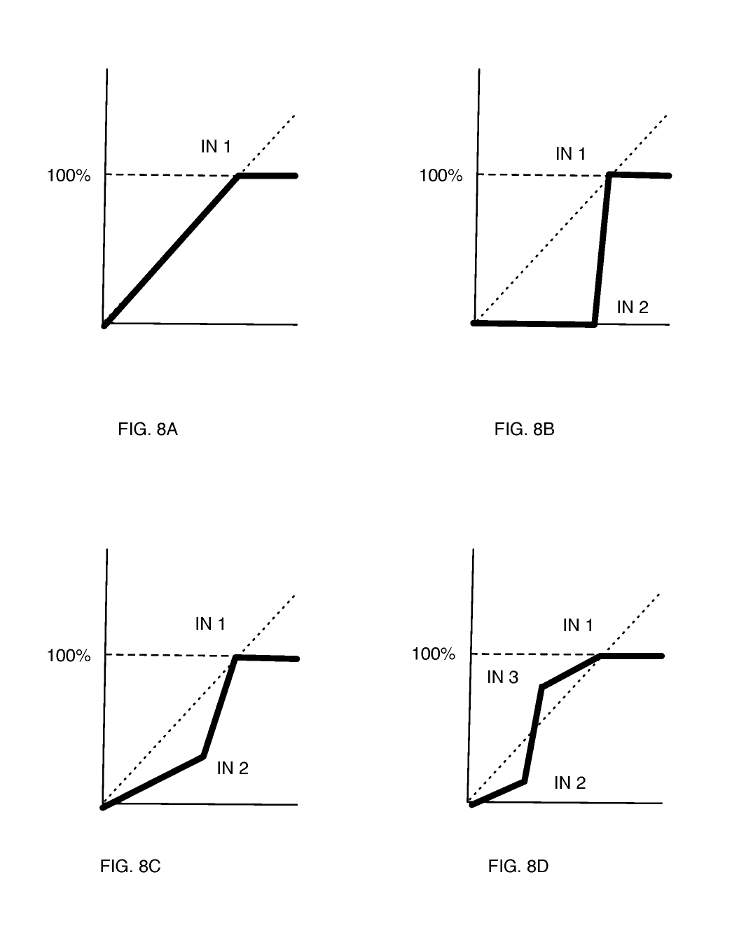

FIG. 8 illustrates a visualization of satisfaction discount schedules. The underlying information may be captured or edited as tables, or inequality expressions, or procedural instructions. In a embodiment, the inflection points may be inserted and positioned in a graphics editor. FIG. 8A illustrates satisfaction which rises from zero to a single inflection point which denotes 100% satisfaction. More of this KPI has no consequence but any value below the inflection point is rewarded with a linear discount. FIG. 8B illustrates a step function. Other methods of inputting this function may be more convenient. Here it is all or nothing, zero or 100%. Pregnant or not pregnant. Living or Dead. On or Off. FIG. 8C uses at least two inflection points to illustrate a concave (or convex) satisfaction curve. FIG. 8D illustrates using at least 3 inflection points to build a complex curve where there are piece-wise linear segments. Applying a satisfaction discount to a score is done by multiplication and several discounts may be multiplied together.

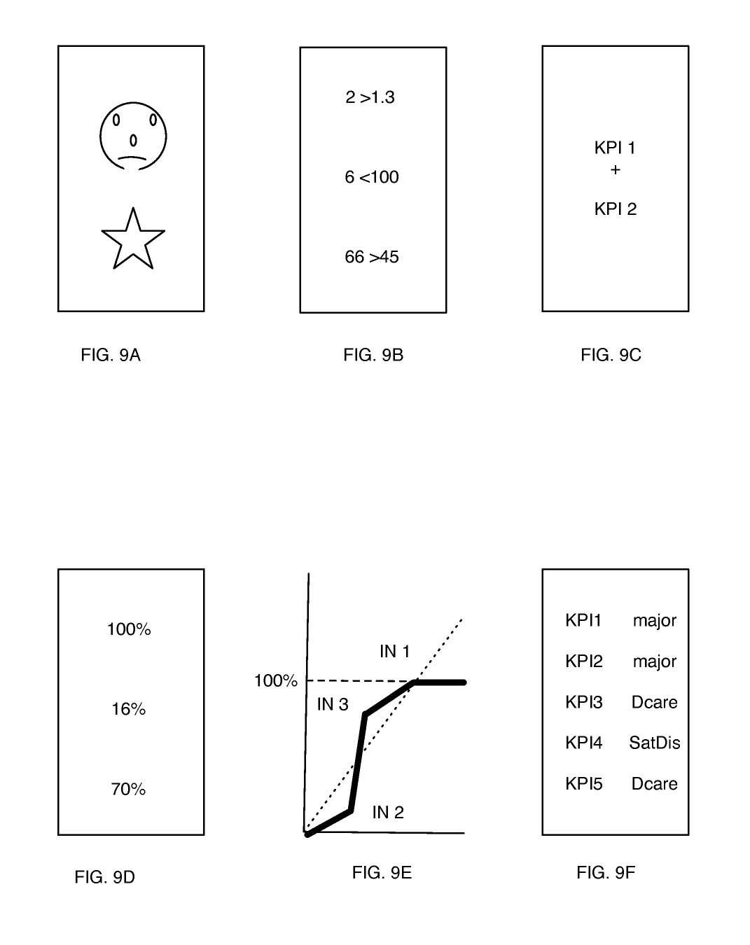

To help the reader appreciate the user model, we provide FIG. 9 A-F. This is a non-limiting exemplary usage of the subject matter. In a purely navigational or expository use, the operator is presented with a plurality of Quality of Service Ratings FIG. 9A and may select one for elaboration i.e. what is the basis for this Rating. Upon selection, FIG. 9B is displayed which shows Quality of Service Scores which have been computed and tested against thresholds. This illustration shows that the scores are evaluated against thresholds. Scores may further be selected by an operator to understand how the score was computed. Upon selection of a score, FIG. 9C illustrates an explication of the details of a computation.

FIG. 9F is a table annotating which KPI are don't care (Dcare) and which KPI are major and used in a Quality of Service Score.

Another aspect of the invention is applying a Satisfaction Discount to QoS Scores based on selected other KPI. It doesn't matter how nutritious a dogfood scores in vitamins and minerals if only 16% of dogs will eat it. FIG. 9D illustrates a display provided to the user upon selection which shows the discount which is applied to QoS Scores before determining QoS Ratings. Upon selection, a display shows how a satisfaction discount is determined. This could be in the form of a table, an algebraic expression, procedural steps, or a graphic. FIG. 9E is a non-limiting illustration of the relationship of one KPI and its resulting satisfaction discount percentage. Selection of certain KPI as SatDis is also shown in FIG. 9F.

FIGS. 8 and 9 may also be used to illustrate a method of selecting and setting method steps. FIG. 9 F is a user interface for receiving operator selections of don't care KPI, major KPI, and satisfaction discount KPI. FIG. 9E is a graphical user interface for setting inflection points for a satisfaction discount function relating a percentage to a value of a SatDis KPI. FIG. 9C is a user interface for an operator to define the transformation of at least one major KPI into a Quality of Service Score. FIG. 9B is a user interface for an operator to set thresholds for QoS Scores to be determine a QoS Rating which is displayed in FIG. 9A.

An apparatus embodiment comprises a processor comprised of RAM, CPU, and I/Q configured by a communicatively coupled instruction store to display a total QoS rating derived by a circuit to assign a total rating coupled to a circuit to select a rating scale and to a circuit to adjust a total QoS score.

In an embodiment the apparatus further comprises a circuit to determine a raw QoS score, a circuit to determine a QoS Score adjustment, a circuit to determine and bin each major and each minor KPI, and a circuit to select major KPI, thresholds, and dimensions.

A software program product embodiment comprises instructions encoded on a computer-readable storage device to configure a processor to execute the computer method to adjust a total QoS score by determining a raw QoS score from the lowest of a plurality of major KPI and subtract a QoS score adjustment by weighting, adding, and normalizing minor KPI scores.

In an embodiment the software program product further comprises instructions to control a display of Quality of Service scores by applying rating scales and to determine QoS scores by applying thresholds to selected KPI over selected dimensions.

A system embodiment comprises means for determining and binning key performance indicators, means for determining a raw QoS score and a QoS score adjustment, means for adjusting a total QoS score and assigning a total QoS rating.

In an embodiment the system further comprises means for displaying a total QoS score rating, means for selecting dimensions, KPI, thresholds, and rating scales, and means for navigating to view component KPI and scores from which the rating is derived.

A non-limiting exemplary alternate embodiment of the invention is disclosed below.

A process of drilling-down comprises selection and highlighting of a selected rating initiating operative display of the combined score and the threshold and the components of the score in an interactive manner is useful in order to find the source of a quality problem. For example, in the case when the KPI_DIMENSIONS are MDN and Busy-Hour, and there are 100,000 MDNs in the set. After displaying the resulting QoS ratings for each MDN, there may be some MDNs with a less than acceptable QoS rating. In order to gain better visibility as to the source of the less than acceptable QoS ratings, means are provided to re-define the KPI_DIMENSIONS, to re-compute the KPIs corresponding to these new KPI_DIMENSIONs, and to compute a new set of QoS ratings and scores corresponding to these new KPI_DIMENSIONS. Suppose that 100 MDNs from the total set of 100,000 show poor average signal quality. The embodiment provides means for adding a KPI_DIMENSION to the set, in a non-limiting example: base-station identification. After re-computing the KPIs and QoS ratings corresponding to this new dimension, the embodiment provides means for displaying 50,000 KPI scores, corresponding to 100 base stations, corresponding to 10,000 MDNs that associate with those base stations over the busy hour, where each MDN is associated with 5 base stations over the busy hour. In this case the embodiment provides means for displaying for each MDN, a QoS score and rating corresponding to each of 5 base stations. Continuing with the example, the embodiment provides means for determining that the poor QoS score and rating occurs for one of the 5 base stations. Accordingly, the embodiment provides means for interactively redefining the KPI_DIMENSIONs, in a closed loop system, after reviewing an initial QoS result, and determining more precisely the source of the problem whereby the QoS system is superior to conventional systems for debugging quality issues. It is now apparent why defining the KPI_DIMENSION in a closed loop manner is important to the QoS system.

In an embodiment, controlling a display to show a QoS rating provides a means to link to key performance indicators that are responsible for said QoS rating. The problem devices, their locations, configurations, and measured parameters are displayable from selection of the resultant QoS rating display.

Service Performance at the mobile device is determined for at least one service type by a computer-implemented method of distilling KPIs into a single score and rating. For the purpose of this patent application, Ratings are defined as a subjective description of a score relative to one or more thresholds. A rating may be Pass or Fail based on a single threshold. For the purpose of this patent application Scores are defined as numerical values which can be averaged, normalized, summed, weighted, multiplied, and otherwise arithmetically and statistically manipulated.

For each type of service, major KPIs are selected which dominate a combined score by receiving user selections, a table, or computer readable file. Program steps configure a processor to determine when all of the selected major KPIs meet or exceed a threshold in order for the combined score to attain that threshold. In an embodiment, major KPIs are combined in a multi-value analog AND operation, whereby a score (i.e., value) above the common part achieved by any KPI is chopped off because it does not correspond to the other KPIs. The worst performance of all the major KPI sets the limit. Different types of service may be defined in a computer-readable input table to have various thresholds for any one KPI and not have the same number or types of KPI included.

A Quality of Service Rating is determined by comparing a combined Quality of Service Score with at least one numerical threshold. It is understood that ratings are descriptive words or symbols and may be text strings, colors, smells, symbols, icons, sounds, equivalent to changing the tangible transformation of data to sensory representation. Selecting, highlighting, or drilling-down into a selected rating displays the combined score and the threshold and the components of the score.

In an embodiment the reduction for each non-excellent rating is normalized. In an embodiment, the reduction for each non-excellent rating is scaled where scaled means if there are several non-excellent ratings of decreasing desirability, the reduction is greater for lower desirability rating.

Each element of a summary display is hyper linked to its underlying data or equation. This allows drilling into a problem area to determine the significant contributing causes.

An embodiment of the invention is a computer-method to transform samples of data from a plurality of wireless communication apparatus which are configured to record data according to a collection profile. The method includes reading from a data storage device files which include non-dynamic characteristics such as configuration, and unique identifiers along with quality of service measurements taken at certain times, certain locations, and certain environmental conditions including the radio channel.

One method comprises the following steps: Identifying at least two subsets, corresponding to groups of measurements, distinguished according to at least a first characteristic. These subsets are chosen according to a dimension (i.e., characteristic) over which a Quality of Service (QoS) score is to be computed. As a non-limiting example, a dimension could correspond to geographical points such as cellular tower locations, corresponding to each measurement. Thus, correspondingly each point, which is an element in the dimension, is associated with a subset of corresponding measurements. In one embodiment, a dimension is defined on any measurement characteristic or Key Performance Indicator (KPI) derived from a measurement characteristic and furthermore a plurality of such dimensions can be chosen. In an embodiment, a dimension is a combination of measurement characteristics and referential data.

Computing a QoS score for each subset of measurements corresponding to the chosen dimensional set. Computing a QoS score is comprised of the following. Computing at least one KPI from a measurement characteristic and determining a QoS score based on at least one threshold.

Determining and displaying a QoS score for each subset in the dimensional set which enables correlation and confidence level between changes in Quality of Service Score for a first subset and a second subset and changes in a characteristic or a measurement that distinguishes the first subset from the second subset.

Providing by configuring a processor communicatively coupled to a display, selection, and input apparatus: menus, checkboxes, sliders, text entry forms to receive a selection of measurement characteristics, QoS thresholds, KPI definitions and in addition to define at least one Dimension resulting in at least two subsets of the plurality of wireless communication apparatus.

Providing graphical or formulaic entry control by configuring a processor communicatively coupled to a display, selection, and input apparatus to express a determination method for a Quality of Service Score. Providing a computer-implemented user interface to receive a set of ranges or limits, comparisons, and selection of characteristics for selecting subsets and for determining a Quality of Service Rating.

In an embodiment, a Quality of Service score is determined for each of a plurality of subsets.

The method comprises reading stored data packages recorded at a plurality of wireless communication devices according to a collection profile, wherein data packages comprise unique identifiers and characteristics and recorded transitory data; providing a selection control panel on a computer display by configuring a processor through which characteristics may be scoped, limited, aggregated, or categorized; receiving selection of at least one dimension and at least one range or limit with which data packages can be organized into subsets, determining a Quality of Service Score for each subset; when a Quality of Service Score is substantially disparate among a plurality of subset, determining a correlation with plausible causality between variations in Quality of Service and the independent characteristics.

In an embodiment, the method comprises the following steps: Reading m packages of metrics which may be located in an n dimensional space, receiving a range of values in at least one dimension and selecting metrics which are bounded by the dimension and range of values, computing at least one Key Performance Indicator from the selected metrics, receiving at least p limits for each Key Performance Indicator and assigning each KPI into one of p+1 bins, determining a ceiling for a total quality of service value if a KPI is major, determining an adjustment for a quality of service value as a percentage, applying one or more adjustments to the lowest ceiling of quality of service values, grading an adjusted total quality of service value according to a scale.

In an other embodiment, Quality of Service is compared on different dimensions. In another embodiment, Interactive analysis provides a way to interactively drill down to discover the dominant constituent part contributing to a Quality of Service rating or score.

In an embodiment of the present invention, measures recorded at a plurality of wireless communication devices are transformed into Key Performance Indicators (KPIs). Each KPI is normalized, that is transformed to a common scale shared by all KPIs.

In an embodiment, each KPI which is numerical is transformed into a rating which is non-numerical. In an embodiment a rating is formulated from a normalized KPI. In an other embodiment, a rating is formulated from a non-normalized KPI.

In an embodiment a selectable dimension is selected. At each position in the selectable dimension, the method computes the Composite QoS score and Rating. By computing the Composite QoS score at each increment of the selectable dimension, the method obtains local maxima or local minima at certain coordinates.

In order to provide interactive discovery of troublesome phenomena, Composite QoS Rating and Scores are displayed as hyperlinks in an electronic document. By selectively navigating through the hyperlinks, a user may cause new computation of intermediate QoS scores and ratings. A user may select new selected dimensions to decompose into constituent scores and ratings. The selectable decomposition into constituent parts may reveal the cause of an unsatisfactory Composite Rating.

In another embodiment, the Quality of Service ratings are represented as variable sizes, colors, patterns, or symbols for each bin, and for each sub-bin.

An other aspect of the invention is an interactive method for operation of an apparatus comprising a processor coupled to a computer readable instruction store and a computer readable data store, the processor further coupled to a display apparatus, the method configures the processor by instructions to configure the display apparatus to traverse a hierarchy of stored Quality of Service Ratings, scores, and measurements recorded by a plurality of wireless communication devices: displaying a plurality of selectable Quality of Service (QoS) Ratings on a display apparatus communicatively coupled to a processor; receiving a selection of one of the plurality of selectable Quality of Service Ratings; and displaying a plurality of selectable major Key Performance Indicator (KPI) ratings on a display apparatus communicatively coupled to the processor.

Exemplary embodiments include:

Embodiments of the present invention include systems, apparatus, and methods for a processor to transform measurements taken from a mobile radio device into displays of Quality of Service.

One aspect of the invention is a method for operation of a display apparatus coupled to a system, which includes the following steps: displaying upon request at least one Quality of Service (QoS) Rating; upon user selection, displaying a threshold and a normalized Quality of Service (nQoS) Score which determined the displayed QoS Rating; and upon user selection, displaying any adjustment(s) applied to an aggregate Quality of Service (aQoS) Score which determined the displayed nQoS Score.

In an embodiment, the method further includes: upon user selection, displaying a human readable representation of a transformation of major Key Performance Indicators (mKPI) into the aQoS score.

In an embodiment, the method further includes: upon user selection, displaying a selection of Key Performance Indicators into one of mKPI and don't care indicators (DCI).

In an embodiment, the method further includes: displaying Satistfaction Discount (SD) factors applied to each aQoS Score.

In an embodiment, the method further includes: upon user selection, displaying a visualization of inflection points determining SD factors (tables, step graphs, non-linear graphs, inequalities, etc.).

In various embodiments, a visualization is at least one of the following group: a table, a step graph, a piecewise non-linear graph, and an expression including inequality operators, or their functional equivalents.

In an embodiment, the method further includes: upon user selection, displaying a Key Performance Indicator which was assigned to an SD factor.

In an embodiment, the method further includes: displaying a selection of a Key Performance Indicator into one of a first satisfaction discount (SD) factor, mKPI and don't care indicator (DCI).

In an embodiment, the method further includes: displaying a selection of a Key Performance Indicator into one of a second satisfaction discount (SD) factor, mKPI and don't care indicator (DCI).

In an embodiment, the method of operating a display apparatus coupled to a system is: displaying upon request at least one Quality of Service (QoS) Rating; upon user selection, displaying a threshold and a normalized Quality of Service (nQoS) Score which determined the displayed QoS Rating; upon user selection, displaying any adjustment(s) applied to an aggregate Quality of Service (aQoS) Score which determined the displayed nQoS Score; upon selection, displaying a human readable representation of a transformation of major Key Performance Indicators (mKPI) into the aQoS score; upon selection, displaying a selection of Key Performance Indicators into one of mKPI and don't care indicators (DCI); displaying Satistfaction Discount (SD) factors applied to each aQoS Score; upon user selection, displaying a visualization of inflection points determining SD factors (tables, step graphs, non-linear graphs, inequalities, etc.); upon user selection, displaying a Key Performance Indicator which was assigned to an SD factor; displaying a selection of a Key Performance Indicator into one of a first satisfaction discount (SD) factor, mKPI and don't care indicator (DCI); displaying a selection of a Key Performance Indicator into one of a second satisfaction discount (SD) factor, mKPI and don't care indicator (DCI).

Another independent aspect of the invention is a computer-implemented method including the following steps: receiving, from a user interface device, selection of a KPI as a major KPI, and selection of a KPI as a don't care KPI.

In an embodiment, the method further includes: receiving from a user interface device, selection of a KPI as a first satisfaction discount (SD) factor; selection of a KPI as a second SD factor; and receiving from a user interface device, for each SD factor, selection of a first inflection point determination of an equal to or above threshold value which determines a 100% satisfaction discount factor.

In an embodiment, the method further includes: receiving from a user interface device, selection of a second inflection point determination of less than threshold value which determines a lowest satisfaction discount factor.

In an embodiment, the method further includes: receiving from a user interface device, selection of one or more inflection points between the first inflection point and the second inflection point determination of ranges of values and their corresponding satisfaction discount factors.

In an embodiment, the method further includes: receiving from a user interface device, at least one of a formulaic, procedural, or functional description of transformation of one or more major key performance indicators (mKPI) into an aggregate Quality of Service (aQoS) Score.

In an embodiment, the method further includes: transforming mKPI into aQos.

In an embodiment, the method further includes: adjusting aQoS Score into a normalizedQuality of Service (nQoS) Score by multiplying by the percentage of at least one SD factor.

In an embodiment, the method further includes: receiving from a user interface device, at least one threshold for nQoS Scores to distinguish a first Quality of Service Rating from a second Quality of Service Rating.

In an embodiment, the method further includes: receiving from a user interface device, selection of a KPI as a major KPI, selection of a KPI as a don't care KPI, receiving from a user interface device, selection of a KPI as a first satisfaction discount (SD) factor; selection of a KPI as a second SD factor; receiving from a user interface device, for each SD factor, selection of a first inflection point determination of an equal to or above threshold value which determines a 100% satisfaction discount factor; receiving from a user interface device, selection of a second inflection point determination of less than threshold value which determines a lowest satisfaction discount factor; receiving from a user interface device, selection of one or more inflection points between the first inflection point and the second inflection point determination of ranges of values and their corresponding satisfaction discount factors; receiving from a user interface device, a formulaic, procedural, or functional description of transformation of one or more major key performance indicators (mKPI) into an aggregate Quality of Service (aQoS) Score, transforming mKPI into aQos; adjusting aQoS Score into a normalized Quality of Service (nQoS) Score by multiplying by at least one SD factor percentage; receiving from a user interface device, at least one threshold for nQoS Scores to distinguish a first Quality of Service Rating from a second Quality of Service Rating.

### CONCLUSION

We distinguish the invention by providing multidimensional analysis of the KPIs which may correlate with either satisfactory or unsatisfactory Quality of Service Ratings. We distinguish the invention by providing interactive drilling down to reveal which KPI were selected to determine an inferior Quality of Service rating.

The present invention is further distinguished by providing means for receiving and recategorizing stored data into subsets according to multiple dimensions and limits or ranges in each dimension and determining and displaying Quality of Service scores and ratings in each dimension and correlating changes in Quality of Service with changes in data recorded at wireless communication apparatus in the same dimension. It is particularly pointed out that the dimensions are defined and selected after the data is stored.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

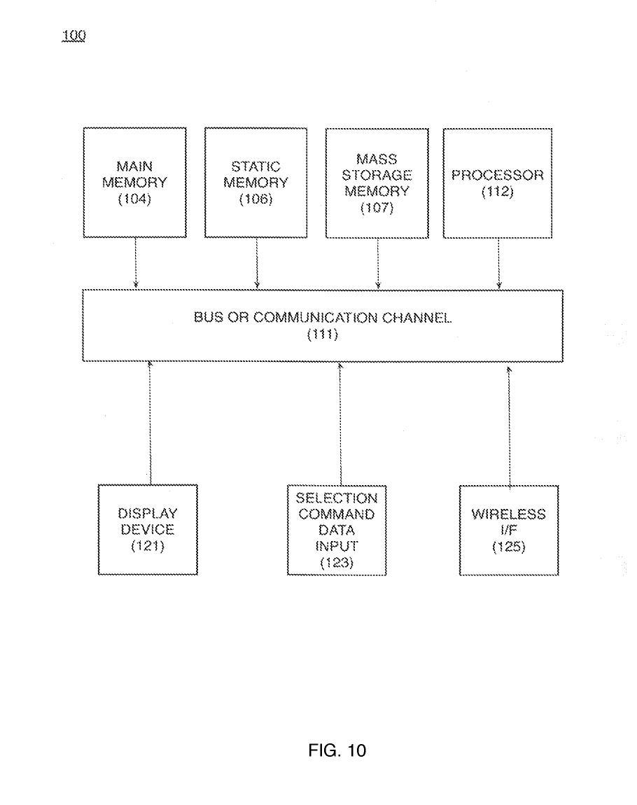

FIG. 10 illustrates an exemplary programmable processor comprising a bus or communication channel 111 coupling main memory 104, static memory 106, mass storage memory 107, and a processor circuit 112 for executing instructions, and in embodiments at least one interface to couple a display device 121, a selection command data input 123, and/or a wireless interface 125.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Computer-readable storage media suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

### SEQUENCE LISTING

Not Applicable

We claim:

1. A method for interactive operation of a display apparatus coupled to a system, comprising:
displaying upon request at least one Quality of Service (QoS) Rating; upon user selection,
displaying a threshold and a normalized Quality of Service (nQoS) Score which determined the displayed QoS Rating; and upon user selection,
displaying any adjustment(s) applied to an aggregate Quality of Service (aQoS) Score which determined the displayed nQoS Score.

2. The method of claim 1 further comprising: upon selection,
displaying a human readable representation of a transformation of major Key Performance Indicators (mKPI) into the aQoS score.

3. The method of claim 2 further comprising: upon selection,
displaying a selection of Key Performance Indicators into one of mKPI and don't care indicators (DCI).

4. The method of claim 3 further comprising:
displaying Satistfaction Discount (SD) factors applied to each aQoS Score.

5. The method of claim 4 further comprising: upon user selection,
displaying a visualization of inflection points determining SD factors (tables, step graphs, non-linear graphs, inequalities, etc.).

6. The method of claim 5 wherein a visualization is at least one of the following group: a table, a step graph, a piecewise non-linear graph, and an expression including inequality operators.

7. The method of claim 5 further comprising:
upon user selection,
displaying a Key Performance Indicator which was assigned to an SD factor.

8. The method of claim 7 further comprising:
displaying a selection of a Key Performance Indicator into one of a first satisfaction discount (SD) factor, mKPI and don't care indicator (DCI).

9. The method of claim 8 further comprising:
displaying a selection of a Key Performance Indicator into one of a second satisfaction discount (SD) factor, mKPI and don't care indicator (DCI).

10. A method for operation of a display apparatus coupled to a system, comprising:
displaying upon request at least one Quality of Service (QoS) Rating; upon user selection,
displaying a threshold and a normalized Quality of Service (nQoS) Score which determined the displayed QoS Rating; upon user selection,
displaying any adjustment(s) applied to an aggregate Quality of Service (aQoS) Score which determined the displayed nQoS Score; upon selection
displaying a human readable representation of a transformation of major Key Performance Indicators (mKPI) into the aQoS score; upon selection,
displaying a selection of Key Performance Indicators into one of mKPI and don't care indicators (DCI);
displaying Satistfaction Discount (SD) factors applied to each aQoS Score; upon user selection,
displaying a visualization of inflection points determining SD factors (tables, step graphs, non-linear graphs, inequalities, etc.); upon user selection,
displaying a Key Performance Indicator which was assigned to an SD factor;
displaying a selection of a Key Performance Indicator into one of a first satisfaction discount (SD) factor, mKPI and don't care indicator (DCI); and
displaying a selection of a Key Performance Indicator into one of a second satisfaction discount (SD) factor, mKPI and don't care indicator (DCI).

11. A method comprising:
receiving from a user interface device,
selection of a KPI as a major KPI, and
selection of a KPI as a don't care KPI.

12. The method of claim 11 further comprising:
receiving from a user interface device,
selection of a KPI as a first satisfaction discount (SD) factor;
selection of a KPI as a second SD factor; and
receiving from a user interface device, for each SD factor,
selection of a first inflection point determination of an equal to or above threshold value which determines a 100% satisfaction discount factor.

13. The method of claim 12 further comprising:
receiving from a user interface device,
selection of a second inflection point determination of less than threshold value which determines a lowest satisfaction discount factor.

15. The method of claim 14 further comprising:
receiving from a user interface device,
selection of one or more inflection points between the first inflection point and the second inflection point determination of ranges of values and their corresponding satisfaction discount factors.

16. The method of claim 11 further comprising:
receiving from a user interface device,
a formulaic, procedural, or functional description of transformation of one or more major key performance indicators (mKPI) into an aggregate Quality of Service (aQoS) Score,

17. The method of claim 16 further comprising:
transforming mKPI into aQos.

18. The method of claim 17 further comprising:
adjusting aQoS Score into a normalized Quality of Service (nQoS) Score by multiplying by the percentage of at least one SD factor.

19. The method of claim 18 further comprising:
receiving from a user interface device,
at least one threshold for nQoS Scores to distinguish a first Quality of Service Rating from a second Quality of Service Rating.

20. A method comprising:
receiving from a user interface device,
selection of a KPI as a major KPI,
selection of a KPI as a don't care KPI,
receiving from a user interface device,
selection of a KPI as a first satisfaction discount (SD) factor;
selection of a KPI as a second SD factor;
receiving from a user interface device, for each SD factor,
selection of a first inflection point determination of an equal to or above threshold value which determines a 100% satisfaction discount factor;
receiving from a user interface device,
selection of a second inflection point determination of less than threshold value which determines a lowest satisfaction discount factor;
receiving from a user interface device,
selection of one or more inflection points between the first inflection point and the second inflection point determination of ranges of values and their corresponding satisfaction discount factors;
receiving from a user interface device,
a formulaic, procedural, or functional description of transformation of one or more major key performance indicators (mKPI) into an aggregate Quality of Service (aQoS) Score,
transforming mKPI into aQos;
adjusting aQoS Score into a normalizedQuality of Service (nQoS) Score by multiplying by at least one SD factor percentage; and
receiving from a user interface device,
at least one threshold for nQoS Scores to distinguish a first Quality of Service Rating from a second Quality of Service Rating.

21. A method for operating a processor coupled to a display apparatus, comprising:
receiving user selected thresholds and weights for wireless device measurements;
determining assignment of key performance indicators (kpi) into bins for calculation of a numerical quality of service (QoS) scores; and
mapping numerical QoS scores into qualitative QoS ratings according to the user selections.

22. The method of claim 21 further comprising:
receiving user deselection of key performance indicators as “don't care” measurements;
masking said “don't care” measurements out of calculation of quality of service scores and quality of service ratings.

23. The method of claim 22 further comprising:
receiving user selection of a key performance indicator as a satisfaction factor;
receiving a user selected threshold of a key performance indicator as 100% satisfactory;
when a wireless device measurement is below a satisfactory threshold, determining a percentage satisfaction discount factor; and
discounting a QoS score by multiplying it by the satisfaction discount factor.

24. An interactive method for operation of an apparatus comprising a processor coupled to a computer readable instruction store and a computer readable data store, the processor further coupled to a display apparatus, the method configures the processor by instructions to configure the display apparatus to traverse a hierarchy of stored Quality of Service Ratings, scores, and measures recorded by a plurality of wireless communication devices:
displaying a plurality of selectable Quality of Service (QoS) Ratings on the display apparatus communicatively coupled to a processor;
receiving a selection of one of the plurality of selectable Quality of Service Ratings; and
displaying a plurality of selectable Key Performance Indicator (KPI) scores on the display apparatus communicatively coupled to the processor.

25. The method of claim 24 wherein receiving a selection of one of the plurality of selectable QoS Rating further comprises:
retrieving from a computer-readable non-transitory media a plurality of measures which were transformed into the selected Quality of Service Rating;
transforming the measures into each Key Performance Indicator (KPI) numerical score related to the selected Quality of Service Rating:
normalizing each KPI numerical score to a common scale shared by all KPI's;
masking out KPI's selected by a user as “don't care”; and
determining a rating for each KPI by comparing at least one inequality threshold to the normalized KPI numerical score.

26. The method of claim 24 further comprises:
receiving a selection of one of the displayed ratings,
displaying at least one inequality threshold for the selected KPI rating,
displaying a numerical score for the selected rating, and
displaying the measures which were transformed into the numerical score related to the selected rating.

27. The method of claim 24 further comprising:
displaying a plurality of selectable KPI,
receiving a user selected threshold for a 100% acceptable KPI; and
displaying the measures recorded at a plurality of wireless communication devices which were transformed into a satisfaction discount factor.

28. A software program product tangibly embodied as instructions encoded on a computer-readable storage device to configure a processor to execute a computer method to adjust a total QoS score by determining a raw QoS score from the lowest of a plurality of major KPI and multiplying the total QoS score by a percentage to reflect satisfaction; and instructions to apply rating scales and to determine QoS scores by applying thresholds to selected KPI over selected dimensions.

29. A system comprising:
means for determining and binning key performance indicators (KPI),
means for determining a raw Quality of Service (QoS) score,
means for determining and applying a satisfaction discount percentage to adjust a total QoS score,
means for assigning a total QoS rating,
means for displaying a total QoS score rating,
means for selecting dimensions, KPI, thresholds, and rating scales, and
means for navigating to view component KPI and scores from which the rating is derived.
